(19) United States
(12) Patent Application Publication
(10) Pub. No.: US 2023/0181942 A1
(43) Pub. Date: Jun. 15, 2023

(54) APPARATUS AND METHOD FOR OPTIMIZING AIR FLOW IN RESPIRATORY PROTECTIVE DEVICES

(71) Applicant: HONEYWELL INTERNATIONAL INC., Charlotte, NC (US)

(72) Inventors: Hang TIAN, Charlotte, NC (US); Xiaojin HAN, Charlotte, NC (US); Wei SHI, Charlotte, NC (US); Fei WANG, Charlotte, NC (US); Hongbing XIANG, Charlotte, NC (US); En Yi CHEN, Charlotte, NC (US)

(21) Appl. No.: 18/060,860

(22) Filed: Dec. 1, 2022

(30) Foreign Application Priority Data
Dec. 15, 2021 (CN) 202111532654.5

(51) Int. Cl. A62B 18/08; A62B 9/00; A41D 13/11

(52) U.S. Cl. CPC A62B 18/08; A62B 9/006; A41D 13/11

(57) ABSTRACT

Apparatuses and methods for optimizing air flow in respiratory protective devices are provided. For example, an example respiratory protective device may include a pressure sensor component, at least one fan component, and a controller component. In some example, the controller component is configured to receive a plurality of air pressure indications from the pressure sensor component, calculate a breath pattern indication based on the plurality of air pressure indications, determine a forward rotation speed value for the at least one fan component, and determine a forward rotation start signal transmission time point and a forward rotation stop signal transmission time point for the at least one fan component.

### CROSS-REFERENCE TO RELATED APPLICATIONS

This application claims priority pursuant to 35 U.S.C. 119(a) to Chinese Application No. 202111532654.5, filed Dec. 15, 2021, which application is incorporated herein by reference in its entirety.

### FIELD OF THE INVENTION

Example embodiments of the present disclosure relate generally to respiratory protective devices and, more particularly, to apparatuses and methods for optimizing air flow in respiratory protective devices.

### BACKGROUND

Applicant has identified many technical challenges and difficulties associated with masks. For example, many masks may inhibit or restrict air flow.

### BRIEF SUMMARY

Various embodiments described herein relate to methods, apparatuses, and systems for optimizing air flow in respiratory protective devices.

In accordance with various embodiments of the present disclosure, a respiratory protective device is provided. In some embodiments, the respiratory protective device comprises a pressure sensor component disposed on an inner surface of the respiratory protective device, at least one fan component positioned adjacent to an inhalation filtration component of the respiratory protective device, and a controller component in electronic communication with the pressure sensor component and the at least one fan component.

In some embodiments, the controller component is configured to receive a plurality of air pressure indications from the pressure sensor component, wherein the plurality of air pressure indications comprises a plurality of air pressure values; calculate a breath pattern indication based on the plurality of air pressure indications, wherein the breath pattern indication comprises a breath depth value and a breath rate value; determine a forward rotation speed value for the at least one fan component based on the breath depth value of the breath pattern indication; and determine a forward rotation start signal transmission time point and a forward rotation stop signal transmission time point for the at least one fan component based on the forward rotation speed value and the breath rate value of the breath pattern indication.

In some embodiments, the plurality of air pressure values corresponds to time series data.

In some embodiments, the controller component is configured to: determine a plurality of peak air pressure values and a plurality of valley air pressure values based on the plurality of air pressure values and the time series data; calculate a plurality of peak-to-valley height values based on the plurality of peak air pressure values and the plurality of valley air pressure values; determine a maximum peak-to-valley height value from the plurality of peak-to-valley height values; and set the breath depth value based at least in part on the maximum peak-to-valley height value.

In some embodiments, when determining the forward rotation speed value based on the breath depth value, the controller component is configured to: compare the breath depth value with a previous breath depth value. In some embodiments, the previous breath depth value is associated with a previous forward rotation speed value of the at least one fan component.

In some embodiments, the controller component is configured to: determine that the breath depth value increases from the previous breath depth value; calculate a breath depth increase value based on subtracting the previous breath depth value from the breath depth value; determine a forward rotation speed increase value based at least in part on the breath depth increase value; and set the forward rotation speed value based at least in part on adding the forward rotation speed increase value to the previous forward rotation speed value.

In some embodiments, the controller component is configured to: determine that the breath depth value decreases from the previous breath depth value; calculate a breath depth decrease value based on subtracting the breath depth value from the previous breath depth value; determine a forward rotation speed decrease value based at least in part on the breath depth decrease value; and set the forward rotation speed value based at least in part on subtracting the forward rotation speed decrease value from the previous forward rotation speed value.

In some embodiments, when determining the forward rotation start signal transmission time point, the controller component is configured to: calculate a forward rotation speed up adjustment time period based at least in part on the forward rotation speed value; determine an inhalation starting time point based at least in part on the plurality of air pressure indications; and set the forward rotation start signal transmission time point based on the inhalation starting time point and the forward rotation speed up adjustment time period.

In some embodiments, the controller component is configured to: transmit a forward rotation start signal to the at least one fan component at the forward rotation start signal transmission time point.

In some embodiments, when determining the forward rotation stop signal transmission time point, the controller component is configured to: calculate a forward rotation slow down adjustment time period based at least in part on the forward rotation speed value; determine an exhalation starting time point based at least in part on the plurality of air pressure indications; and set the forward rotation stop signal transmission time point based on the exhalation starting time point and the forward rotation slow down adjustment time period.

In some embodiments, the controller component is configured to: transmit a forward rotation stop signal to the at least one fan component at the forward rotation stop signal transmission time point.

In accordance with various embodiments of the present disclosure, an example method is provided. The example method comprises receiving a plurality of air pressure indications from the pressure sensor component, wherein the plurality of air pressure indications comprises a plurality of air pressure values; calculating a breath pattern indication based on the plurality of air pressure indications, wherein the breath pattern indication comprises a breath depth value and a breath rate value; determining a forward rotation speed value for the at least one fan component based on the breath depth value of the breath pattern indication; and determining a forward rotation start signal transmission time point and a forward rotation stop signal transmission time point for the at least one fan component based on the forward rotation speed value and the breath rate value of the breath pattern indication.

In accordance with various embodiments of the present disclosure, a computer program product is provided. The computer program product comprises at least one non-transitory computer-readable storage medium having computer-readable program code portions stored therein. The computer-readable program code portions comprise an executable portion configured to receive a plurality of air pressure indications from the pressure sensor component, wherein the plurality of air pressure indications comprises a plurality of air pressure values; calculate a breath pattern indication based on the plurality of air pressure indications, wherein the breath pattern indication comprises a breath depth value and a breath rate value; determine a forward rotation speed value for the at least one fan component based on the breath depth value of the breath pattern indication; and determine a forward rotation start signal transmission time point and a forward rotation stop signal transmission time point for the at least one fan component based on the forward rotation speed value and the breath rate value of the breath pattern indication.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example perspective view of an example respiratory protective device in accordance with some example embodiments described herein;

FIG. 2A illustrates an example exploded view of an example mask component in accordance with some example embodiments described herein;

FIG. 2B illustrates another example exploded view of an example mask component in accordance with some example embodiments described herein;

FIG. 2C illustrates another example exploded view of an example mask component in accordance with some example embodiments described herein;

FIG. 2D illustrates an example back view of an example mask component in accordance with some example embodiments described herein;

FIG. 3 illustrates an example circuit diagram of an example respiratory protective device in accordance with some example embodiments described herein;

FIG. 4 illustrates an example method of optimizing air flow in an example respiratory protective device in accordance with some example embodiments described herein;

FIG. 5 illustrates an example method of determining breath depth value in accordance with some example embodiments described herein;

FIG. 6 illustrates an example diagram of example air pressure indications received from an example pressure sensor component in accordance with some example embodiments described herein;

FIG. 7 illustrates an example method of setting an example forward rotation speed value for an example fan component in accordance with some example embodiments described herein;

FIG. 8 illustrates an example method of determining an example forward rotation start signal transmission time point for an example fan component in accordance with some example embodiments described herein;

FIG. 9 illustrates an example method of determining an example forward rotation stop signal transmission time point for an example fan component in accordance with some example embodiments described herein; and

FIG. 10 illustrates an example breath flow diagram and an example fan speed diagram in accordance with some example embodiments described herein.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

Respiratory protective devices (such as, but not limited to, masks, respirators, and/or the like) can protect our health, especially in the COVID-19 pandemic. For example, wearing a respiratory protective device can help slow the spread of the virus, and people are recommended or required to wear face masks in indoor public places and outdoors where there is a high risk of COVID-19 transmission (such as crowded events or large gatherings).

However, many respiratory protective devices are plagued by technical disadvantages and difficulties, resulting in people not wearing them even when there is infection risk. For example, many users are unable to breathe enough air through the respiratory protective device, especially when they are exercising (e.g. running). As such, the user may not feel comfortable to wear such a respiratory protective device (especially when the user is also wearing glasses and/or during summer).

PAPR (Powered Air Purifying Respirator) is an air-purifying respirator that uses a blower to force air through filter cartridges or canisters and into the breathing zone of the wearer. However, PAPR is heavy due to complex electrical and mechanical components, and its use time is very limited (mainly caused by battery capacity constraints). As such, PAPR is mostly for industrial scenarios.

Various embodiments of the present disclosure overcome these technical difficulties and challenges, and provide various technical improvements and benefits. For example, while filters may provide resistance to air flow, example embodiments of the present disclosure may implement a fan component to help optimize air flow. Various embodiments of the present disclosure balance the need for air flow and battery life as the mask is a small device worn on the face. In some embodiments, when more air volume for easy breathing is needed, the fan speed of the fan component may be increased. In some embodiments, when the battery needs to last longer, the fan speed of the fan component may decrease. As such, various embodiments of the present disclosure provide adaptive fan control for different scenarios. For example, various embodiments of the present disclosure increase fan speed when the user needs more air (such as during running), and stop the fan or decrease fan speed as much as possible (such as when the user is exhaling).

Various embodiments of the present disclosure cause the fan to start and/or stop in advance as the fan has its speed adjustment time. In particular, fans are mechanical devices, and their speed adjustment lags behind their trigger signal (about 100˜500 ms). People breathe every 2˜3 seconds. For example, a user's normal breath rate may be 16˜20 breath per minute. When a user is running, the breath rate may be 30˜40 per minute. Without compensating the lag time Δt, user experience can decrease 10˜25%. For example, at an early inhalation phase from exhalation, the fan component does not pull air in or pulls air in at a slow speed, and hence decreases comfort for the user to breaths. At an early exhalation phase from inhalation, the fan still pulls air in for 100˜500 ms, and hence decreases the efficiency for breathing.

Various embodiments of the present disclosure overcome the above technical challenges, provide various technical benefits and improvements, and improve user experience. For example, various embodiments of the present disclosure may form a close control loop with various electronic components. For example, embodiments of the present disclosure may provide embedded pressure sensor in the enclosed space within the respiratory protective device, may include integrated fans on both sides to help with air flow, and may provide a microcontroller unit with firmware to control the fan speed according to the pressure signals from the pressure sensors. As such, various embodiments of the present disclosure provide a solution to measure pressure inside the mask, to calculate breath pattern, and then to optimize the fan speed to synchronize air flow with breath rhythm.

In some embodiments, software/algorithms stored in the microcontroller unit can compensate the lag time of fan speed up and slow down according to the pressure sensor. In some embodiments, the fan may be a 3-speeds fan (low, middle, and high). For example, different fan speeds have different lag times for speeding up and slowing down. The lag time is predetermined and stored in the microcontroller unit (including the lag times for low/middle/high speed settings). For example, the speed up lag time might be 250 ms for the high speed setting, while the slow down lag time might be 80 ms for the low speed setting.

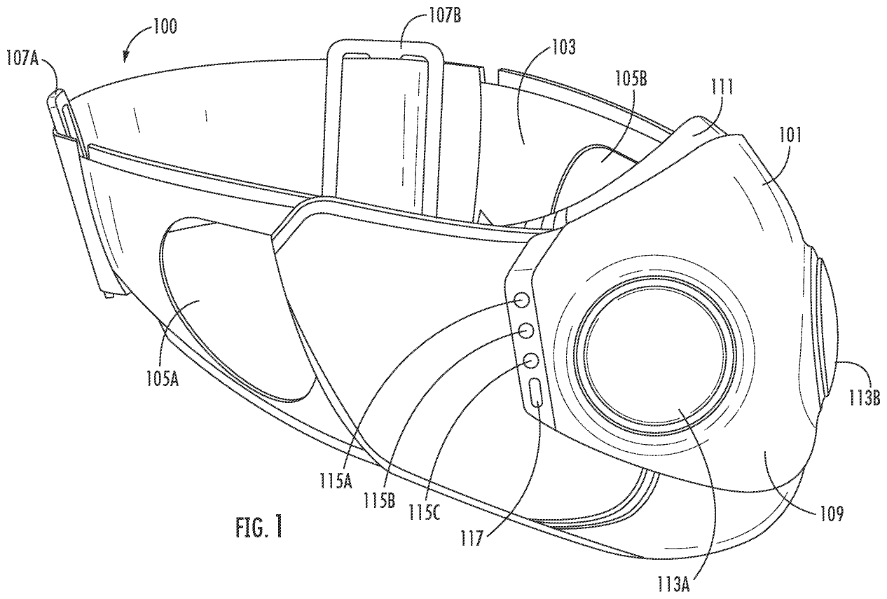

Referring now to FIG. 1, an example perspective view of an example respiratory protective device (also referred to as a respiratory protective equipment) 100 in accordance with some example embodiments described herein is illustrated.

In some embodiments, the example respiratory protective device 100 is in the form of a respirator or a mask. For example, as shown in FIG. 1, the example respiratory protective device 100 comprises a mask component 101 and a strap component 103.

In some embodiments, the strap component 103 may be in the form of a mask strap. For example, in some embodiments, the strap component 103 may comprise elastic material(s) such as, but not limited to, polymers, thermoplastic elastomer (TPE), and/or the like. In some embodiments, the elastic material may allow the example respiratory protective device 100 to be secured to a user's face.

In some embodiments, the strap component 103 may comprise an ear opening 105A and an ear opening 105B. When the example respiratory protective device 100 is worn by a user, the ear opening 105A and the ear opening 105B may allow the user's left ear and the right ear to pass through.

In some embodiments, the strap component 103 may be inserted through one or more strap bucket components (such as a strap bucket component 107A and a strap bucket component 107B as shown in FIG. 1). In some embodiments, the one or more strap bucket components may be in the form of one or more buckles that include, but not limited to, a tri-glide buckle), and may allow a user to adjust the length of the strap component 103 so that the example respiratory protective device 100 can be secured to a user's face.

In some embodiments, the mask component 101 is connected to the strap component 103. For example, a first end of the strap component 103 is connected to a first end of the mask component 101, and a second end of the strap component 103 is connected to a second of the mask component 101. In this example, the first end of the mask component 101 is opposite to the second end of the mask component 101. In the example shown in FIG. 1, an end of the strap component 103 may be secured to the mask component 101 via a fastener component 117 (such as, but not limited to, a snap button).

In some embodiments, the mask component 101 may be in the form of a mask or a respirator. For example, as shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or an inner shell component of the mask component as described herein).

In particular, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. As described above, the example respiratory protective device 100 includes strap component 103 that allows the example respiratory protective device 100 to be secured to the user's face. As such, the face seal component 111 can create at least partially enclosed (or entirely enclosed) space between at least a portion of the user's face (e.g. mouth, nostrils, etc.), details of which are described herein.

In some embodiments, the mask component 101 comprises one or more puck components that cover one or more inhalation filtration components of the example respiratory protective device 100. For example, as shown in FIG. 1, the example respiratory protective device 100 comprises a first puck component 113A that is disposed on a left side of the outer shell component 109 and a second puck component 113B that is disposed on a right side of the outer shell component 109. In such an example, the first puck component 113A covers a first inhalation filtration component that is disposed on the left side of the mask component 101, and the second puck component 113B covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C) that may allow a user to manually control the operations of the fan component of the mask component 101 and/or other devices (such as, but not limited to, earphones) that are in electronic communication with the example respiratory protective device 100.

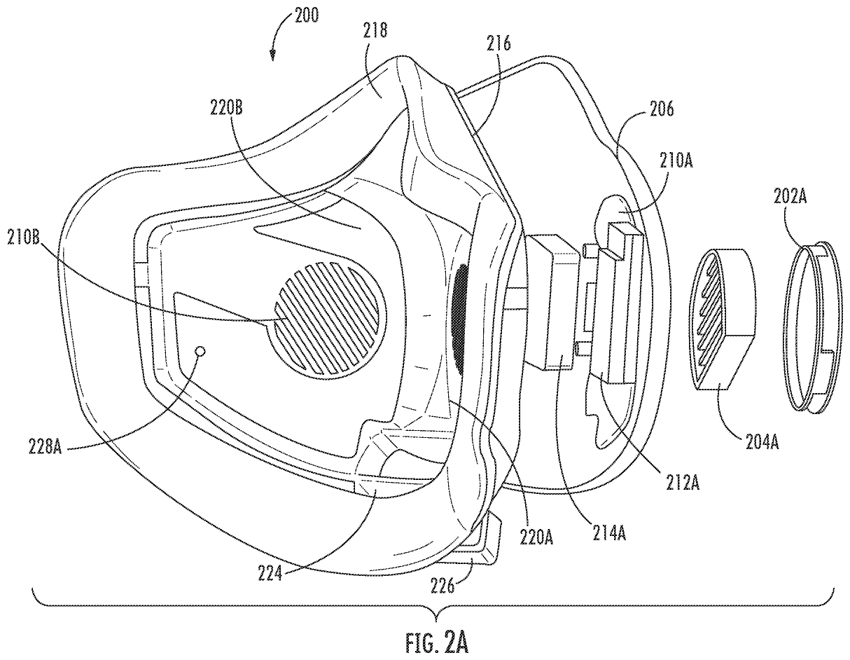

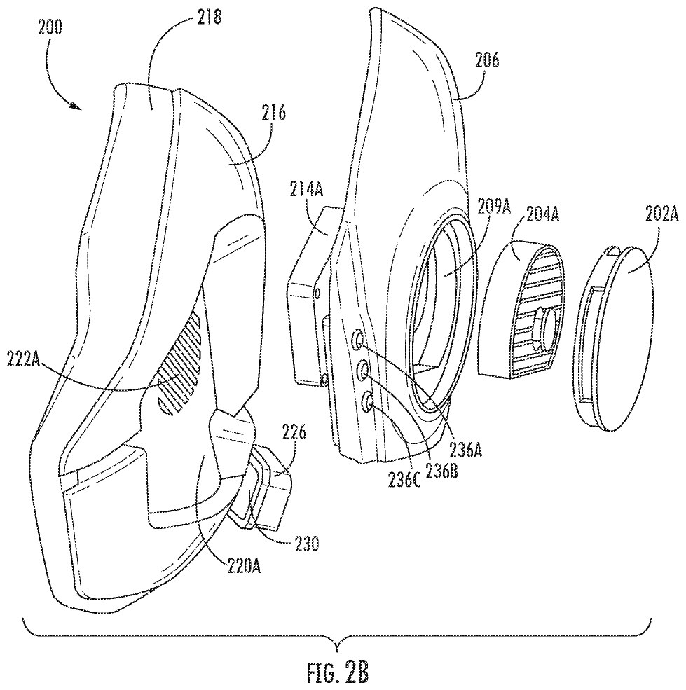

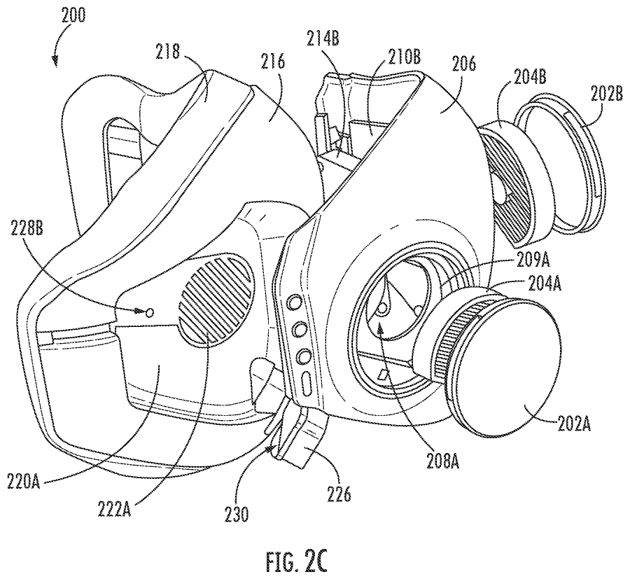

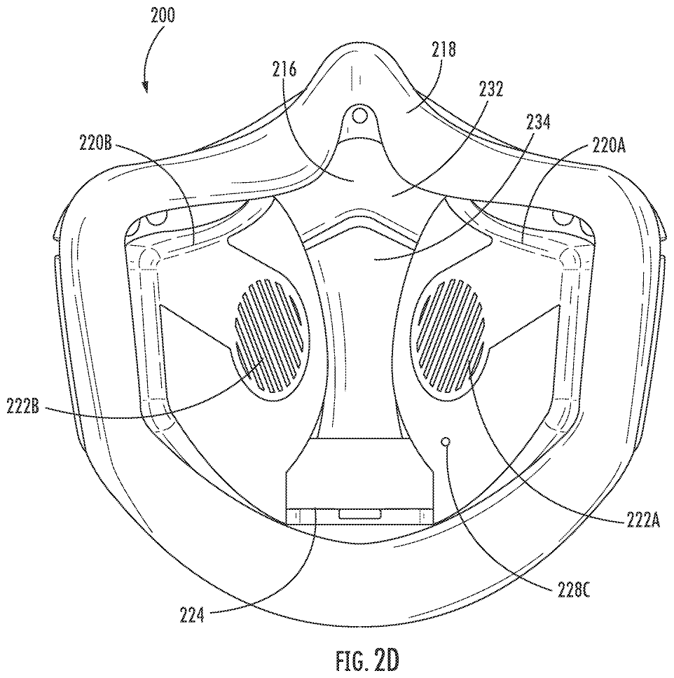

Referring now to FIG. 2A, FIG. 2B, FIG. 2C, and FIG. 2D, examples views of an example mask component 200 in accordance with some example embodiments described herein are illustrated. In particular, FIG. 2A to FIG. 2C illustrate example exploded views of the example mask component 200, and FIG. 2D illustrates an example back view of the example mask component 200.

As shown in FIG. 2A, the mask component 200 comprises an outer shell component 206 and an inner shell component 216.

In some embodiments, the inner shell component 216 may be in a shape that is based on the contour of the user's face. In particular, when the mask component 200 is worn by a user, at least a portion of the user's face (such as, but not limited to, mouth, nostrils) are housed within the inner shell component 216.

In some embodiments, the mask component 200 may comprise a face seal component 218. In some embodiments, the face seal component 218 is attached to and extends from a periphery and/or edge of the inner shell component 216. Similar to the face seal component 111 described above in connection with FIG. 1, the face seal component 216 may comprise soft material such as, but not limited to, silica gel.

In some embodiments, when the mask component 200 is worn by a user, the face seal component 218 and an inner surface of the inner shell component 216 create an enclosed space on at least a portion of the user's face (e.g. on the mouth, nostrils, etc.).

Similar to the inner shell component 216 described above, the shape of the outer shell component 206 may be based on a contour of the user's face. In some embodiments, when the mask component 200 is assembled, the inner surface of the outer shell component 206 is secured to an outer surface of the inner shell component 216. In some embodiments, the inner shell component 216 may comprise one or more indentation portions on the outer surface of inner shell component 216.

For example, referring now to FIG. 2B, the inner shell component 216 may comprise inner shell indentation portions such as, but not limited to, an inner shell indentation portion 220A that is on a left side of the mask component 200 and an inner shell indentation portion 220B that is on a right side of the mask component 200. In particular, each of the inner shell indentation portion 220A and inner shell indentation portion 220B may be sunken or depressed from the outer surface of inner shell component 216. As such, when the outer shell component 206 is secured to the inner shell component 216, the indentation portions may create space that houses electronic components.

Referring back to FIG. 2A, in some embodiments, one or more circuit board components (such as, but not limited to, a circuit board component 210A), one or more charging circuit components (such as, but not limited to, a charging circuit component 212A), and one or more fan components (such as, but not limited to, a fan component 214A) may be disposed in the space that is defined by the inner shell indentation portion 220A and the inner surface of the outer shell component 206. Similarly, one or more circuit board components (such as, but not limited to, a circuit board component 210B), one or more charging circuit components, and one or more fan components (such as, but not limited to, a fan component 214B) may be disposed in the space that is defined by the inner shell indentation portion 220B and the inner surface of the outer shell component 206. For example, the fan component 214A may be disposed on the right side of the example respiratory protective device 200 and the fan component 214B may be disposed on the left side of the example respiratory protective device 200.

In some embodiments, the circuit board component 210A comprises a circuit board (such as, but not limited to a printed circuit board (PCB)) where other electronic components can be secured to and be in electronic communications with one another. For example, a controller component, the charging circuit component 212A and the fan component 214A may be secured to the circuit board component 210A and be in electronic communication with one another.

In some embodiments, the charging circuit component 212A may comprise a charging circuit and/or a battery that supplies power to the controller component and/or the fan component 214A. For example, the charging circuit may include a Universal Serial Bus (USB) charger circuit that is connected to a rechargeable battery.

In some embodiments, the fan component 214A may comprise an electric fan. In some embodiments, the electric fan of the fan component 214A may operate at different rotation speeds. For example, the fan component 214A may be a stepped fan that provides different, predetermined settings for the rotation speeds. Additionally, or alternatively, the fan component 214A may be a stepless fan that enables continuous adjustment of the rotation speed.

In some embodiments, the electric fan of the fan component 214A may operate at different rotational directions. For example, the fan component 214A may operate in a forward direction or a reverse direction. As an example, when the fan component 214A operates in the forward rotational direction, the electric fan of the fan component 214A may rotate counter-clockwise (when viewing from a user wearing the mask component 200) and/or may operate as a blower that draws air from outside the mask component 200 to inside the mask component 200. As another example, when the fan component 214A operates in the reverse rotational direction, the electric fan of the fan component 214A may rotate clockwise (when viewing from a user wearing the mask component 200) and/or may operate as an exhaust/ventilation fan that draws air from inside the mask component 200 to outside the mask component 200.

In some embodiments, the start time, the stop time, the rotational directions (e.g. forward direction or reverse direction) and/or the rotation speed of the electric fan of the fan component 214A may be controlled and/or adjusted by the controller component.

For example, the controller component may transmit a forward rotation start signal to the fan component 214A that causes the fan component 214A to start forward rotation (e.g. start operating as a blower that draws air from outside the mask component 200 towards inside the mask component 200). In some embodiments, the forward rotation start signal may include a forward rotation speed value that indicates the speed for the fan component 214A. Additionally, or alternatively, the controller component may transmit a forward rotation stop signal to the fan component 214A that causes the fan component 214A to stop forward rotation.

Additionally, or alternatively, the controller component may transmit a reverse rotation start signal to the fan component 214A that causes the fan component 214A to start reverse rotation (e.g. start operating as an exhaust fan that draws air from inside the mask component 200 towards outside the mask component 200). In some embodiments, the reverse rotation start signal may include a reverse rotation speed value that indicates the speed for the fan component 214A. Additionally, or alternatively, the controller component may transmit a reverse rotation stop signal to the fan component 214A that causes the fan component 214A to stop reverse rotation.

Referring now to FIG. 2C, the mask component 200 may comprise one or more inhalation filtration components (such as, but not limited to, inhalation filtration component 204A and inhalation filtration component 204B) and one or more puck components (such as, but not limited to puck component 202A and puck component 202B).

In some embodiments, each of the one or more inhalation filtration components may comprise a filter media element that comprise filter material for filtering air. Examples of filter material include, but are not limited to, HEPA filters. In some embodiments, each of the one or more puck components may be positioned to cover one of the inhalation filtration components so as to prolong the lifespan of the mask component 200. For example, the puck component 202A may cover the inhalation filtration component 204A, and the puck component 202B may cover the inhalation filtration component 204B.

As shown in FIG. 2C, the outer shell component 206 of the example mask component 200 may comprise one or more outer shell indentation portions (such as the outer shell indentation portion 209A). In particular, each of the outer shell indentation portion 209A may be sunken or depressed from the outer surface of outer shell component 206. In some embodiments, one or more inhalation filtration components may be disposed in the outer shell indentation portions. For example, as shown in FIG. 2C, an inhalation filtration component 204A is disposed in the outer shell indentation portion 209A.

In some embodiments, each of the one or more outer shell indentation portions may comprise an air inlet opening, and each of the one or more inner shell indentation portions may comprise one or more air inlet slots. In some embodiments, when the mask component 200 is assembled and in use, the air inlet opening on the outer shell indentation portion is aligned with the one or more air inlet slots on the inner shell indentation portion.

For example, as shown in FIG. 2C, the air inlet opening 208A on the outer shell indentation portion 209A of the outer shell component 206 is aligned with the air inlet slots 222A on the inner shell indentation portion 220A of the inner shell component 216.

In this example, when the mask component 200 is worn by a user and the user inhales, air is drawn from the outside environment and travels through the inhalation filtration component 204A, through the air inlet opening 208A, through the air inlet slots 222A, and arrive at the user's mouth or nostrils. As described above and shown in FIG. 2A and FIG. 2B, the fan component 214A is disposed on the inner shell indentation portion 220A (where the air inlet slots 222A are located). In some embodiments, when the user inhales, the fan component 214A may operate in a forward direction that draws air from outside the mask component 200 towards inside the mask component 200, thereby facilitating the inhaling of the user.

Referring now to FIG. 2D, an example back view of the example mask component 200. In particular, FIG. 2D illustrates the view of the example mask component 200 when it is worn by a user and viewed by the user.

As shown in FIG. 2D, the example mask component 200 may comprise air inlet slots 222A that are located on the middle right side of the inner shell component 216, and air inlet slots 222B that are located on the middle left side of the inner shell component 216. For example, the inner surface 232 of the inner shell component 216 may comprise a nose portion 234, where a user may put his or her nose when the mask component 200 is worn. In this example, the air inlet slots 222A may be located to the right of the nose portion 234, and the air inlet slots 222B may be located to the left of the nose portion 234.

In some embodiments, the example mask component 200 may comprise an outlet opening 224 that is on a middle bottom portion of the inner shell component 216. In some embodiments, the outlet opening 224 may be located corresponding to the position of the user's mouth. For example, when a user exhales, the breath may be released through the outlet opening 224.

As shown in FIG. 2A to FIG. 2C, an exhalation filtration component 226 may be connected to the inner shell component 216 at the outlet opening 224. For example, the exhalation filtration component 226 may cover the outlet opening 224. In some embodiments, the exhalation filtration component 226 may comprise a filter media element that comprise filter material for filtering air. Examples of filter material include, but are not limited to, HEPA filters. As such, the breath that is exhaled by the user may be filtered before it is released from inside the mask component 200 to the outside environment.

In some embodiments, the exhalation filtration component 226 may comprise an air quality sensor component 230 that at least partially covers the outlet opening 224 of the inner shell component 216. The air quality sensor component 230 may comprise an air quality sensor that may, for example but not limited to, detect particulate matters in the outer environment, in the enclosed space and/or in the breath exhaled by the user. Examples of the air quality sensor component 230 include, but are not limited to, metal oxide sensors, electrochemical sensors, photo ionization detectors, optical particle counters, optical sensors, and/or the like. In some embodiments, the air quality sensor component 230 is in electronic communication with the controller component, and may transmit air quality indications to the controller component indicating the detected air quality.

In some embodiments, the mask component 200 may comprise one or more pressure sensor components. As described above and as shown in FIG. 2B, when the mask component 200 is worn by a user, the face seal component 218 and an inner surface 232 of the inner shell component 216 create an enclosed space on at least a portion of the user's face (e.g. on the mouth, nostrils, etc.). In some embodiments, a pressure sensor component may comprise a pressure sensor that detects the air pressure within this enclosed space. Examples of the pressure sensor components include, but are not limited to, resistive air pressure transducer or strain gauge, capacitive air pressure transducer, inductive air pressure transducer, and/or the like.

For example, as shown in FIG. 2A, a pressure sensor component 228A may be disposed on an inner surface of the inner shell component 216. Additionally, or alternatively, as shown in FIG. 2C, a pressure sensor component 228B may be disposed on the inner shell indentation portion 220A of the inner shell component 216. Additionally, or alternatively, as shown in FIG. 2D, a pressure sensor component 228C may be disposed on the inner surface of the inner shell component 216. The pressure sensor component 228A, the pressure sensor component 228B, and/or the pressure sensor component 228C may detect the air pressure within the enclosed space defined by the face seal component 218 and the inner shell component 216 on at least a portion of the user's face.

In some embodiments, the one or more pressure sensor components are in electronic communication with the controller component, and may transmit air pressure indications to the controller component indicating the detected air pressure. For example, each of the air pressure indications may comprise an air pressure value that corresponds to the air pressure in the enclosed space as defined by the face seal component 218 and the inner shell component 216.

While the description above provides an example mask component, it is noted that the scope of the present disclosure is not limited to the description above. In some examples, an example mask component may comprise one or more additional and/or alternative elements. For example, an example mask component may comprise less than two or more than two fan components. Additionally, or alternatively, an example mask component may comprise less than two or more than two inhalation filtration components.

In some embodiments, mask component 200 may include one or more key components, such as, but not limited to, a key component 236A, a key component 236B, and a key component 236C. In some embodiments, the one or more key components may be disposed on an outer surface of the outer shell component 206. Each of the one or more key components may provide a button that allow a user to control and/or adjust the operations of various electronic components described herein (such as, but not limited to, fan components, earphones, and/or the like.)

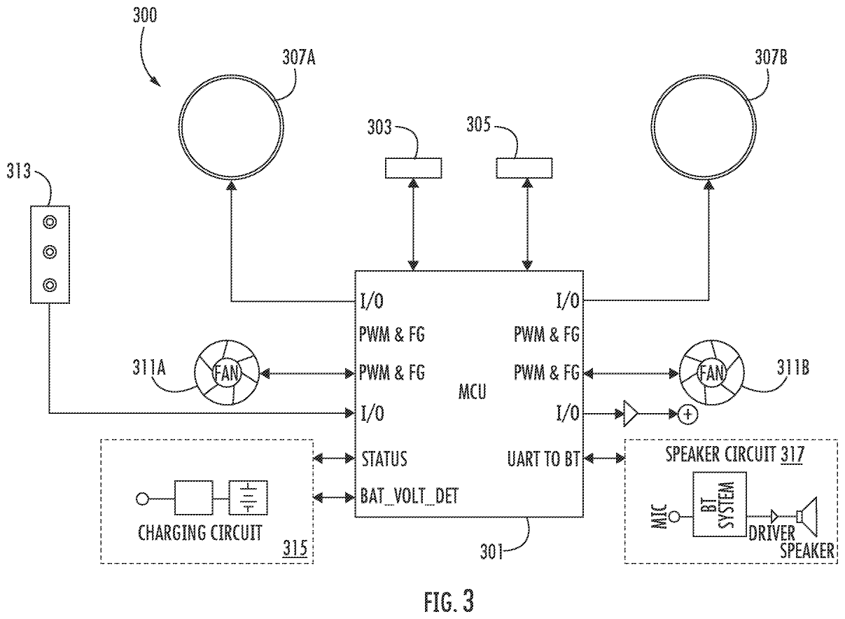

Referring now to FIG. 3, an example circuit diagram of an example respiratory protective device 300 in accordance with some example embodiments described herein is illustrated. In particular, FIG. 3 illustrates example electronic components of an example respiratory protective device in accordance with various example embodiments of the present disclosure.

As shown in FIG. 3, the example respiratory protective device 300 may comprise a controller component 301 that is in electronic communications with other components such as, but not limited to, the pressure sensor component 303, the air quality sensor component 305, a light 307A and a light 307B that are disposed on one or more puck components, fan component 311A, fan component 311B, key components 313, and/or the speaker circuit 317.

In some embodiments, the controller component 301 may be embodied as means including one or more microprocessors with accompanying digital signal processor(s), one or more processor(s) without an accompanying digital signal processor, one or more coprocessors, one or more multicore processors, one or more controllers, processors, one or more computers, various other processing elements including integrated circuits such as, for example, an application specific integrated circuit (ASIC), programmable logic controller (PLC) or field programmable gate array (FPGA), or some combination thereof. Accordingly, although illustrated in FIG. 3 as a single processor, in an embodiment, the controller component 301 may include a plurality of processors and signal processing modules. The plurality of processors may be in operative communication with each other and may be collectively configured to perform one or more functionalities as described herein. In an example embodiment, the controller component 301 may be configured to execute instructions stored in a memory circuitry or otherwise accessible to the controller component.

Whether configured by hardware, firmware/software methods, or by a combination thereof, the controller component 301 may include an entity capable of performing operations according to embodiments of the present disclosure while configured accordingly. Thus, for example, when the controller component 301 is embodied as an ASIC, PLC, FPGA or the like, the controller component 301 may include specifically configured hardware for conducting one or more operations described herein. Alternatively, as another example, when the controller component 301 is embodied as an executor of instructions, such as may be stored in the memory circuitry, the instructions may specifically configure the controller component 301 to perform one or more algorithms and operations described herein.

Thus, the controller component 301 used herein may refer to a programmable microprocessor, microcomputer or multiple processor chip or chips that can be configured by software instructions (applications) to perform a variety of functions, including the functions of the various embodiments described above.

In some embodiments, the memory circuitry may include suitable logic, circuitry, and/or interfaces that are adapted to store a set of instructions that is executable by the controller component 301 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an example embodiment, the memory circuitry may be integrated with the controller component 301 on a single chip, without departing from the scope of the disclosure.

In some embodiments, the pressure sensor component 303 may transmit air pressure indications to the controller component 301. As described above, each of the air pressure indications may comprise an air pressure value that corresponds to the air pressure in the enclosed space as defined by the face seal component 218 and the inner shell component 216.

In some embodiments, the air quality sensor component 305 may transmit air quality indications to the controller component 301. As described above, the air quality indications may indicate a quality of the air in the outer environment, in the enclosed space and/or in the breath exhaled by the user.

In some embodiments, the controller component 301 may transmit control signals to the light 307A and/or the light 307B so as to adjust the color and/or intensity of the light emitted by the light 307A and/or the light 307B.

In some embodiments, the controller component 301 may transmit forward rotation start signals to the fan component 311A and/or the fan component 311B to cause the fan component 311A and/or the fan component 311B to start forward rotation. In some embodiments, the controller component 301 may transmit forward rotation stop signals to the fan component 311A and/or the fan component 311B to cause the fan component 311A and/or the fan component 311B to stop forward rotation.

In some embodiments, the controller component 301 may transmit reverse rotation start signals to the fan component 311A and/or the fan component 311B to cause the fan component 311A and/or the fan component 311B to start reverse rotation. In some embodiments, the controller component 301 may transmit reverse rotation stop signals to the fan component 311A and/or the fan component 311B to cause the fan component 311A and/or the fan component 311B to stop reverse rotation.

In some embodiments, the controller component 301 is in electronic communication with the key components 313. For example, when a user presses a button on the key components 313, the key components 313 may transmit a signal to the controller component 301.

In some embodiments, the controller component 301 is in electronic communication with the speaker circuit 317. For example, the controller component 301 may transmit control signals to an earphone in the speaker circuit 317 so as to adjust volume, noise canceling mode, and/or the like of the earphone.

In some embodiments, the charging circuit 315 supplies power to controller component 301 and one or more other electronic components shown in FIG. 3 (such as, but not limited to, the fan component 311A and the fan component 311B).

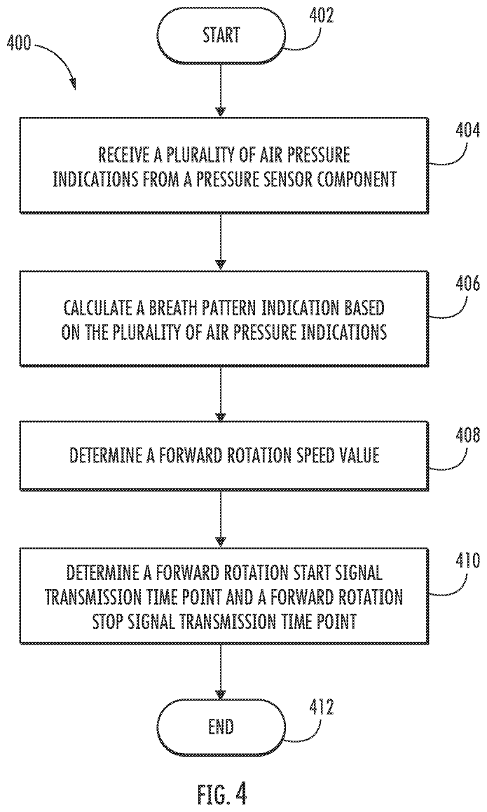

Referring now to FIG. 4 to FIG. 10, example diagrams illustrating example methods in accordance with various embodiments of the present disclosure are illustrated.

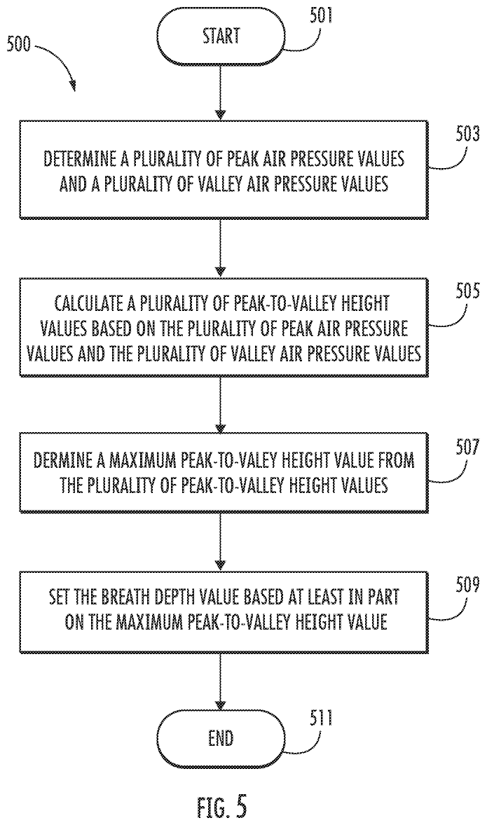

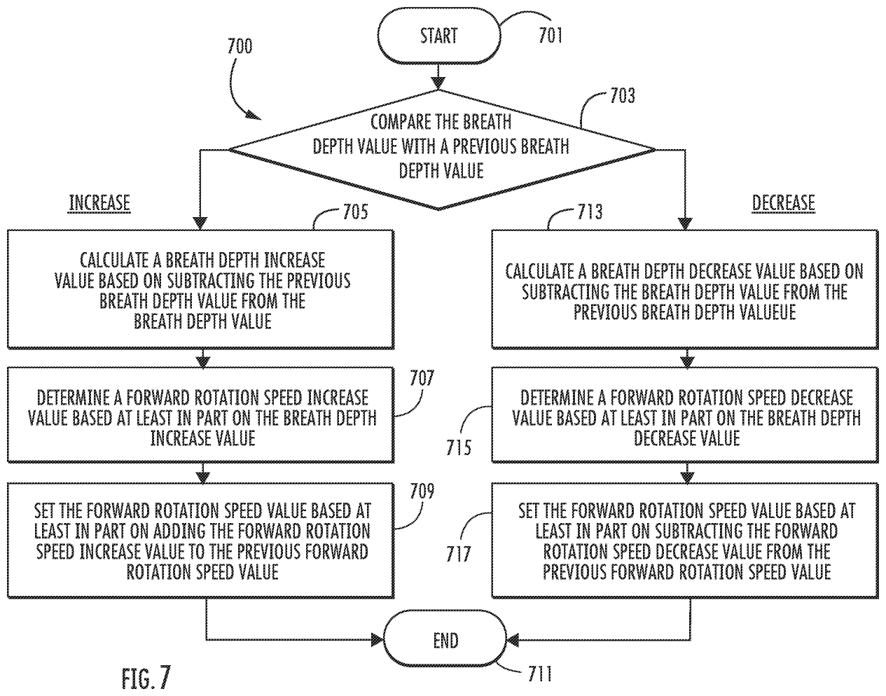

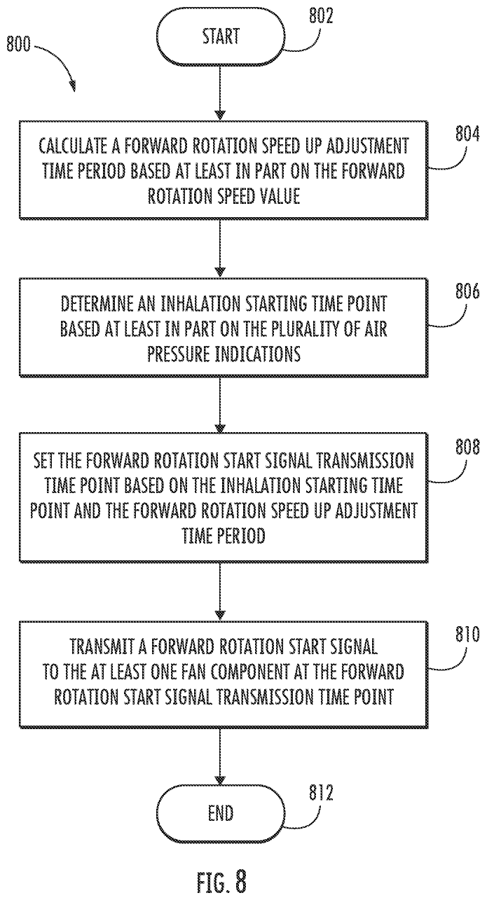

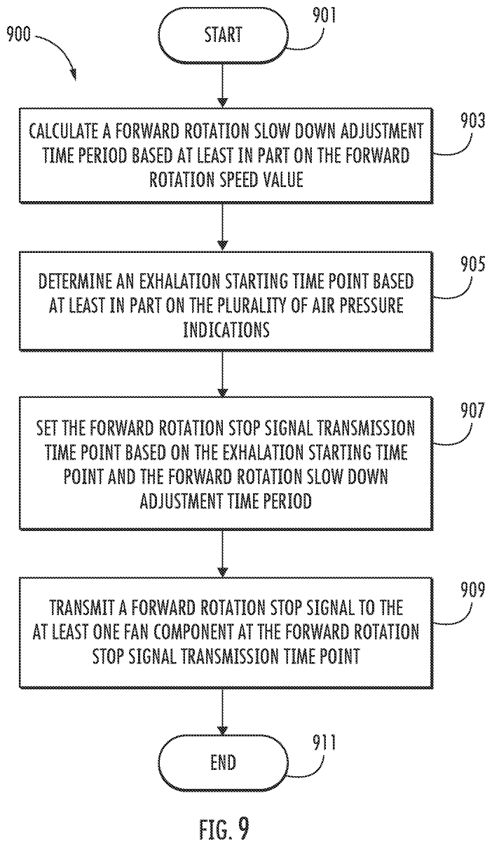

It is noted that each block of the flowchart, and combinations of blocks in the flowchart, may be implemented by various means such as hardware, firmware, circuitry and/or other devices associated with execution of software including one or more computer program instructions. For example, one or more of the steps/operations described in FIG. 4, FIG. 5, FIG. 7, FIG. 8, and FIG. 9 may be embodied by computer program instructions, which may be stored by a non-transitory memory of an apparatus employing an embodiment of the present disclosure and executed by a processing circuitry in the apparatus. For example, these computer program instructions may direct the example controller component 301 described above in connection with FIG. 3 to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Referring now to FIG. 4, an example method 400 of optimizing air flow in an example respiratory protective device in accordance with some example embodiments described herein is illustrated.

In FIG. 4, the example method 400 starts at step/operation 402. In some embodiments, subsequent to and/or in response to step/operation 402, the example method 400 proceeds to step/operation 404. At step/operation 404, a controller component (such as, but not limited to, the controller component 301 of the example respiratory protective device 300 described in connection with FIG. 3 above) may receive a plurality of air pressure indications from a pressure sensor component.

In some embodiments, the plurality of air pressure indications comprises a plurality of air pressure values. For example, as described above, when an example respiratory protective device in accordance with various example embodiments of the present disclosure is worn by the user, an enclosed space is created between at least a portion of the user's face (e.g. nose, nostrils, etc.), the face seal component, and an inner surface of the inner shell component. In some embodiments, the pressure sensor component may be positioned to detect the air pressure within this enclosed space.

In some embodiments, when a user inhales and draws air from the enclosed space, the air pressure is reduced, and the pressure sensor component may detect a reduced air pressure value, generate an air pressure indication, and transmit the air pressure indication to the controller component. Additionally, or alternatively, when a user exhales and releases breath into the enclosed space, the air pressure is increased, and the pressure sensor component may detect an increased air pressure value, generate an air pressure indication, and transmit the air pressure indication to the controller component.

Referring back to FIG. 4, subsequent to and/or in response to step/operation 404, the example method 400 proceeds to step/operation 406. At step/operation 406, a controller component (such as, but not limited to, the controller component 301 of the example respiratory protective device 300 described in connection with FIG. 3 above) may calculate a breath pattern indication based on the plurality of air pressure indications.

As described above, when a user inhales, the air pressure is reduced. When a user exhales, the air pressure is increased. In some embodiments, the pressure sensor component may continuously measure the air pressure values, and therefore may calculate the breath pattern indication based on the air pressure indications. In some embodiments, the plurality of air pressure values corresponds to time series data. For example, each time series data may indicate when the air pressure is detected.

In some embodiments, the breath pattern indication comprises a breath depth value and a breath rate value.

In the present disclosure, the “breath depth value” corresponds to a value of a tidal volume of a user's breathing. In some embodiments, the breath depth value indicates a volume of air that a user inhales and exhales per breath. For example, the breath depth value may be the volume of gas that is moved in and out of the lungs of a user per breath.

In the present disclosure, the “breath rate value” corresponds to a value of the respiratory rate of a user's breathing. In some embodiments, the breath depth value indicates a frequency of the user inhaling and exhaling per a time unit. For example, the breath rate value corresponds to the number of breaths that a user completes per minute.

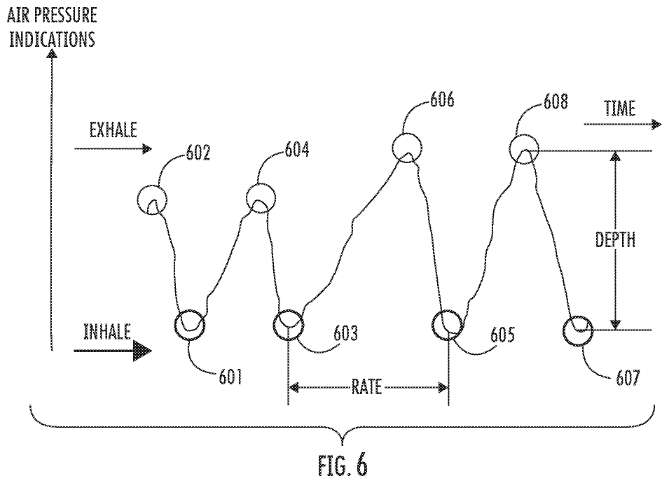

For example, FIG. 6 illustrates an example diagram of example air pressure indications received from an example pressure sensor component in accordance with some example embodiments described herein. In particular, the example diagram illustrates example air pressure changes as the user inhales and exhales.

As shown in FIG. 6, when a user inhales, the air pressure is reduced as reflected by a reduced air pressure value of the air pressure indication. When a user exhales, the air pressure is increased as reflected by an increased air pressure value of the air pressure indication. As described above, each of the plurality of air pressure values corresponds to a time code indicating when the air pressure is detected. As such, by plotting the air pressure values (Y-axis) based on their corresponding time codes (X-axis), the controller component may generate a plot line as shown in FIG. 6 that reflects an air pressure change waveform corresponding to the user's breath pattern indication. In some embodiments, the breath depth value of the breath pattern indication may correspond to an amplitude of the air pressure change waveform, and the breath rate value may correspond to a frequency of the air pressure change waveform.

Referring back to FIG. 4, subsequent to and/or in response to step/operation 406, the example method 400 proceeds to step/operation 408. At step/operation 408, a controller component (such as, but not limited to, the controller component 301 of the example respiratory protective device 300 described in connection with FIG. 3 above) may determine a forward rotation speed value.

In some embodiments, the forward rotation speed value is a value for a speed at which one or more fan components of the example respiratory protective device is set to operate in the forward rotation mode (e.g. draws air from outside the example respiratory protective device to inside the example respiratory protective device). In some embodiments, the controller component may determine the forward rotation speed value for at least one fan component based on the breath depth value of the breath pattern indication.

As described above, the breath depth value corresponds to a volume of air that a user inhales and/or exhales in a breath. If the breath depth value increases (e.g. the user inhales/exhales more air), the forward rotation speed value can be increased so that more air can be drawn from outside the example respiratory protective device to inside the example respiratory protective device. If the breath depth value decreases (e.g. the user inhales/exhales less air), the forward rotation speed value can be decreased so that less air is drawn from outside the example respiratory protective device to inside the example respiratory protective device. As such, various embodiments of the present disclosure may improve user experience while wearing the example respiratory protective device.

Referring back to FIG. 4, subsequent to and/or in response to step/operation 408, the example method 400 proceeds to step/operation 410. At step/operation 410, a controller component (such as, but not limited to, the controller component 301 of the example respiratory protective device 300 described in connection with FIG. 3 above) may determine a forward rotation start signal transmission time point and a forward rotation stop signal transmission time point.

In some embodiments, the controller component may determine the forward rotation start signal transmission time point and the forward rotation stop signal transmission time point for the at least one fan component based on the forward rotation speed value and the breath rate value of the breath pattern indication.

In the present disclosure, the term “forward rotation start signal transmission time point” refers to a time at which the controller component transmits a forward rotation start signal to one or more fan components of the example respiratory protective device so that the one or more fan components can start forward rotation. In some embodiments, the forward rotation start signal comprises the forward rotation speed value determined at step/operation 408.

In some embodiments, the fan component may receive the forward rotation start signal when it is idle (e.g. when its rotation speed is zero) or when it is running in the reverse rotation mode. As such, there is a time delay between the forward rotation start signal transmission time and the time when the fan component reaches the forward rotation speed value. In some examples, the controller component may determine when a user starts inhaling (for example, based on the breath rate value), and may set the forward rotation start signal transmission time point prior to the time when a user starts inhaling so as to avoid the time delay. In such examples, when the user starts inhaling, the fan component can operate at a speed corresponding to the forward rotation speed value.

In the present disclosure, the term “forward rotation stop signal transmission time point” refers to a time at which the controller component transmits a forward rotation stop signal to one or more fan components of the example respiratory protective device so that the one or more fan components can stop forward rotation. In some embodiments, the fan component may receive the forward rotation stop signal when it is running (e.g. when it is at the forward rotation speed). As such, there is a time delay between the forward rotation stop signal transmission time and the time when the fan component stops running. In some examples, the controller component may determine when a user completes inhaling and starts exhaling (for example, based on the breath rate value), and may set the forward rotation stop signal transmission time point prior to the time when a user starts exhaling so as to avoid the time delay. In such examples, when the user starts exhaling, the fan component is idle (i.e. not running).

Referring back to FIG. 4, subsequent to and/or in response to step/operation 410, the example method 400 proceeds to step/operation 412 and ends.

Referring now to FIG. 5, an example method 500 of determining breath depth value in accordance with some example embodiments described herein is illustrated.

In FIG. 5, the example method 500 starts at step/operation 501. In some embodiments, subsequent to and/or in response to step/operation 501, the example method 500 proceeds to step/operation 503. At step/operation 503, a controller component (such as, but not limited to, the controller component 301 of the example respiratory protective device 300 described in connection with FIG. 3 above) may determine a plurality of peak air pressure values and a plurality of valley air pressure values.

In the present disclosure, the term “peak air pressure value” refers to an air pressure value that is more than an earlier air pressure value that is detected immediately prior to the air pressure value and is more than a later air pressure value that is detected immediately subsequent to the air pressure value. As described above, the air pressure increases as a user exhales, and the peak air pressure value corresponds to the air pressure when a user completes an exhalation and starts an inhalation (e.g. an inhalation starting time point).

In the present disclosure, the term “valley air pressure value” refers to an air pressure value that is less than an earlier air pressure value that is measured immediately prior to the air pressure value and is less than a later air pressure value that is measured immediately subsequent to the air pressure value. As described above, the air pressure decreases as a user inhales, and the valley air pressure value corresponds to the air pressure when a user completes an inhalation and starts an exhalation (e.g. an exhalation starting time point).

In some embodiments, the controller component may determine the plurality of peak air pressure values and the plurality of valley air pressure values based on the plurality of air pressure values and the time series data. For example, as shown in FIG. 6, air pressure indications are plotted based on their corresponding time codes, and the controller component may compare each air pressure value with their earlier air pressure value and their later air pressure value to determine peak air pressure values and valley air pressure values. In the example shown in FIG. 6, the controller component may determine the air pressure value 602, the air pressure value 604, the air pressure value 606, and the air pressure value 608 as peak air pressure values, and may determine the air pressure value 601, the air pressure value 603, the air pressure value 605, and the air pressure value 607 as valley air pressure values.

Referring back to FIG. 5, subsequent to and/or in response to step/operation 503, the example method 500 proceeds to step/operation 505. At step/operation 505, a controller component (such as, but not limited to, the controller component 301 of the example respiratory protective device 300 described in connection with FIG. 3 above) may calculate a plurality of peak-to-valley height values based on the plurality of peak air pressure values and the plurality of valley air pressure values.

In the present disclosure, the term “peak-to-valley height value” refers to a difference value between a neighboring peak air pressure value and a neighboring valley air pressure value. As described above, the peak air pressure value corresponds to the air pressure when a user completes an exhale, and the valley air pressure value corresponds to the air pressure when a user completes an inhale. As such, the peak-to-valley height value corresponds to the pressure change from a user's inhalation to the user's exhalation, which in turn corresponds to the volume of air in a breath from the user.

Referring now to FIG. 6, the controller component may calculate a peak-to-valley height value between the air pressure value 601 and the air pressure value 602, may calculate a peak-to-valley height value between the air pressure value 603 and the air pressure value 604, may calculate a peak-to-valley height value between the air pressure value 605 and the air pressure value 606, and may calculate a peak-to-valley height value between the air pressure value 607 and the air pressure value 608.

Referring back to FIG. 5, subsequent to and/or in response to step/operation 505, the example method 500 proceeds to step/operation 507. At step/operation 507, a controller component (such as, but not limited to, the controller component 301 of the example respiratory protective device 300 described in connection with FIG. 3 above) may determine a maximum peak-to-valley height value from the plurality of peak-to-valley height values.

As described above, each of the plurality of peak-to-valley height values corresponds to the volume of air in one breath, and the maximum peak-to-valley height value may indicate the highest volume of air in one breath by the user during the time that the pressure sensor components sense the air pressure.

For example, referring now to FIG. 6, the peak-to-valley height value between the air pressure value 602 and the air pressure value 601 may correspond to the volume of air in the first breath by the user. The peak-to-valley height value between the air pressure value 603 and the air pressure value 604 may correspond to the volume of air in the second breath by the user. The peak-to-valley height value between the air pressure value 605 and the air pressure value 606 may correspond to the volume of air in the third breath by the user. The peak-to-valley height value between the air pressure value 607 and the air pressure value 608 may correspond to the volume of air in the fourth breath by the user. In the example shown in FIG. 6, the controller component may determine that the peak-to-valley height value between the air pressure value 607 and the air pressure value 608 is the maximum peak-to-valley height value.

Referring back to FIG. 5, subsequent to and/or in response to step/operation 507, the example method 500 proceeds to step/operation 509. At step/operation 509, a controller component (such as, but not limited to, the controller component 301 of the example respiratory protective device 300 described in connection with FIG. 3 above) may set the breath depth value based at least in part on the maximum peak-to-valley height value.

For example, the controller component may set the breath depth value as being equal to the maximum peak-to-valley height value. As such, the controller component may determine the breath depth value based on the air pressure indications from the pressure sensor component.

Referring back to FIG. 5, subsequent to and/or in response to step/operation 509, the example method 500 proceeds to step/operation 511 and ends.

Referring now to FIG. 7, an example method 700 of setting an example forward rotation speed value for an example fan component in accordance with some example embodiments described herein is illustrated.

In FIG. 7, the example method 700 starts at step/operation 701. In some embodiments, subsequent to and/or in response to step/operation 701, the example method 700 proceeds to step/operation 703. At step/operation 703, a controller component (such as, but not limited to, the controller component 301 of the example respiratory protective device 300 described in connection with FIG. 3 above) may compare the breath depth value with a previous breath depth value.

In some embodiments, the pressure sensor component may continuously measure the air pressure values, and may continuously calculate the breath depth values of the breath pattern indication based at least in part on the air pressure values in accordance with various examples described above. In some embodiments, the previous breath depth value is calculated based on previous air pressure values that were detected at a previous time point prior to a current time point when current air pressure values are detected. In some embodiments, the breath depth value is calculated based on the current air pressure values.

In some embodiments, the previous breath depth value is associated with a previous forward rotation speed value of the at least one fan component. For example, the previous forward rotation speed value indicates a forward rotation speed of the at least one fan component at the previous time point. In some embodiments, the previous forward rotation speed value is a default speed value of the at least one fan component.

In some embodiments, the controller component may compare the breath depth value with the previous breath depth value, and may determine whether the breath depth value increases or decreases from the previous breath depth value.

For example, when a user wearing the example respiratory protective device stands up and starts running, the breath depth value may increase as the user may require more air in each breath. When the user wearing the example respiratory protective device stops running and starts sitting down, the breath depth value may decrease as the user may require less air in each breath.

Referring back to FIG. 7, if, at step/operation 703, the controller component determines that the breath depth value increases from the previous breath depth value, the example method 700 proceeds to step/operation 705. At step/operation 705, a controller component (such as, but not limited to, the controller component 301 of the example respiratory protective device 300 described in connection with FIG. 3 above) may calculate a breath depth increase value based on subtracting the previous breath depth value from the breath depth value.

For example, the breath depth value may be 300, and the previous breath depth value may be 100. In this example, the controller component determines the breath depth value increases from the previous breath depth value, may calculate the breath depth increase value by subtracting 100 from 300, and may determine that the breath depth increase value is 200.

Referring back to FIG. 7, subsequent to and/or in response to step/operation 705, the example method 700 proceeds to step/operation 707. At step/operation 707, a processing circuitry (such as, but not limited to, the controller component 301 of the example respiratory protective device 300 described in connection with FIG. 3 above) may determine a forward rotation speed increase value based at least in part on the breath depth increase value.

As described above, the increase in breath depth value indicates that the user is breathing more air, and therefore the controller component may increase the forward rotation speed of the fan component so that more air can be drawn into the respiratory protective device (e.g. the mask component). In some embodiments, the increase in the forward rotation speed (as reflected in the forward rotation speed increase value) is proportional to the increase in breath depth (as reflected in the breath depth increase value).

For example, the controller component may multiply the forward rotation speed increase value by a predetermined increase unit value to determine the forward rotation speed increase value. Additionally, or alternatively, one or more predetermined forward rotation speed increase values may be provided to the controller component. Each predetermined forward rotation speed increase value may be associated with a range of breath depth increase values, and the controller component may determine a range of breath depth increase values that the breath depth increase value falls within, and may select the predetermined forward rotation speed increase value that corresponds to the range of breath depth increase values as the forward rotation speed increase value.

Continuing from the example above, the controller component may multiply the breath depth increase value 200 by an example predetermined increase unit value 0.1 to determine the forward rotation speed increase value as 20 RPM.

Referring back to FIG. 7, subsequent to and/or in response to step/operation 707, the example method 700 proceeds to step/operation 709. At step/operation 709, a processing circuitry (such as, but not limited to, the controller component 301 of the example respiratory protective device 300 described in connection with FIG. 3 above) may set the forward rotation speed value based at least in part on adding the forward rotation speed increase value to the previous forward rotation speed value.

Continuing from the example above, the previous forward rotation speed value may be 200 RPM, and the forward rotation speed increase value is 20 RPM. In this example, the controller component may set the forward rotation speed value as 220 RPM.

As illustrated in the above example, in response to determining an increase in the breath depth value, the controller component may increase the forward rotation speed so that more air can be drawn into the example respiratory protective device.

Referring back to FIG. 7, subsequent to and/or in response to step/operation 709, the example method 700 proceeds to step/operation 711 and ends.

If, at step/operation 703, the controller component determines that the breath depth value decreases from the previous breath depth value, the example method 700 proceeds to step/operation 713. At step/operation 713, a controller component (such as, but not limited to, the controller component 301 of the example respiratory protective device 300 described in connection with FIG. 3 above) may calculate a breath depth decrease value based on subtracting the breath depth value from the previous breath depth value.

For example, the breath depth value may be 100, and the previous breath depth value may be 300. In this example, the controller component determines the breath depth value decreases from the previous breath depth value, may calculate the breath depth decrease value by subtracting 100 from 300, and may determine that the breath depth decrease value is 200.

Referring back to FIG. 7, subsequent to and/or in response to step/operation 713, the example method 700 proceeds to step/operation 715. At step/operation 715, a processing circuitry (such as, but not limited to, the controller component 301 of the example respiratory protective device 300 described in connection with FIG. 3 above) may determine a forward rotation speed decrease value based at least in part on the breath depth decrease value.

As described above, the decrease in breath depth value indicates that the user is breathing less air, and therefore the controller component may decrease the forward rotation speed of the fan component so that less air is drawn into the respiratory protective device (e.g. the mask component) and the fan component can consume less power and be quieter. In some embodiments, the decrease in the forward rotation speed (as reflected in the forward rotation speed decrease value) is proportional to the decrease in the breath depth value (as reflected in the breath depth decrease value).

For example, the controller component may multiply the forward rotation speed decrease value by a predetermined decrease unit value to determine the forward rotation speed decrease value. Additionally, or alternatively, one or more predetermined forward rotation speed decrease values may be provided to the controller component. Each predetermined forward rotation speed decrease value may be associated with a range of breath depth decrease values, and the controller component may determine a range of breath depth decrease values that the breath depth decrease value falls within, and may select the predetermined forward rotation speed decrease value that corresponds to the range of breath depth decrease values as the forward rotation speed decrease value.

Continuing from the example above, the controller component may multiply the breath depth decrease value 200 by an example predetermined decrease unit value 0.1 to determine the forward rotation speed decrease value as 20 RPM.

Referring back to FIG. 7, subsequent to and/or in response to step/operation 715, the example method 700 proceeds to step/operation 717. At step/operation 717, a processing circuitry (such as, but not limited to, the controller component 301 of the example respiratory protective device 300 described in connection with FIG. 3 above) may set the forward rotation speed value based at least in part on subtracting the forward rotation speed decrease value from the previous forward rotation speed value.

Continuing from the example above, the previous forward rotation speed value may be 200 RPM, and the forward rotation speed decrease value is 20 RPM. In this example, the controller component may set the forward rotation speed value as 180 RPM.

As illustrated in the above example, in response to determining a decrease in the breath depth value, the controller component may decrease the forward rotation speed so that less air is drawn into the example respiratory protective device.

Referring back to FIG. 7, subsequent to and/or in response to step/operation 717, the example method 700 proceeds to step/operation 711 and ends.

While the description above provides an example of setting the forward rotation speed value, it is noted that the scope of the present disclosure is not limited to the description above.

For example, the fan component may be a stepped fan that provides different, predetermined settings for the rotation speed. In such an example, the controller component may assign a range of breath depth values to each of the predetermined settings for the rotation speed. If the breath depth value falls within a range of breath depth values, the controller component may determine the predetermined setting for the rotation speed that corresponds to the range of breath depth values, and set the forward rotation speed value of the at least one fan component based on the predetermined setting. Additionally, or alternatively, the controller component may multiply the breath depth value by a predetermined speed unit value to determine the forward rotation speed value.

Referring now to FIG. 8, an example method 800 of determining an example forward rotation start signal transmission time point for an example fan component in accordance with some example embodiments described herein is illustrated. As described above, the forward rotation start signal transmission time point refers to a time at which the controller component transmits a forward rotation start signal to one or more fan components of the example respiratory protective device.

In FIG. 8, the example method 800 starts at step/operation 802. In some embodiments, subsequent to and/or in response to step/operation 802, the example method 800 proceeds to step/operation 804. At step/operation 804, a controller component (such as, but not limited to, the controller component 301 of the example respiratory protective device 300 described in connection with FIG. 3 above) may calculate a forward rotation speed up adjustment time period based at least in part on the forward rotation speed value.

In some embodiments, the forward rotation speed value may be calculated based in accordance with various examples described herein, including, but not limited to, at least FIG. 3 to FIG. 7 described above.

In some embodiments, the forward rotation start signal comprises an electronic instruction to the at least one fan component to start forward rotating until reaching at a speed corresponding to the forward rotation speed value. As described above, there may be a time delay between when the forward rotation start signal is received by the at least one fan component and when the fan component operates at the forward rotation speed value. For example, the fan component may receive the forward rotation start signal when it is idle (e.g. when its rotation speed is zero), and may require time to speed up.

In the present disclosure, the term “forward rotation speed up adjustment time period” is the time period during which the fan component speeds up from a current speed (for example, a zero speed or a reverse rotation speed) to the forward rotation speed indicated by the forward rotation speed value. In some embodiments, the forward rotation speed up adjustment time period may be calculated based at least in part on the forward rotation speed value.

For example, the fan component may be a stepped fan that provides different, predetermined settings for the forward rotation speeds, and each predetermined forward rotation speed may correspond to a predetermined forward rotation speed up adjustment time period. In such an example, the controller component may select a predetermined forward rotation speed up adjustment time period that corresponds to a predetermined forward rotation speed as indicated by the forward rotation speed value, and may set the forward rotation speed up adjustment time period as the predetermined forward rotation speed up adjustment time period.

Additionally, or alternatively, the fan component may be a stepless fan that provides continuous adjustments of the forward rotation speeds. In such an example, the controller component may determine the forward rotation speed up adjustment time period based on dividing the forward rotation speed value by the acceleration rate of the fan component. For example, if the forward rotation speed value indicates a speed of 200 RPM, and the acceleration rate of the fan component is 2 RPM per millisecond (e.g. the fan component increases the rotation speed by 2 RPM per millisecond), the controller component may determine that the forward rotation speed up adjustment time period is 100 milliseconds.

Referring back to FIG. 8, subsequent to and/or in response to step/operation 804, the example method 800 proceeds to step/operation 806. At step/operation 806, a controller component (such as, but not limited to, the controller component 301 of the example respiratory protective device 300 described in connection with FIG. 3 above) may determine an inhalation starting time point based at least in part on the plurality of air pressure indications.

As described above, the air pressure increases as a user exhales, and the peak air pressure value corresponds to the air pressure when a user completes an exhalation and starts an inhalation (e.g. an inhalation starting time point). Further, the controller component may calculate the breath rate value based at least in part on the plurality of air pressure indications. In some embodiments, the controller component may determine inhalation starting time point based at least in part on the breath rate value.

For example, the controller component may determine that a user completes a breath every 3 seconds, and may determine that a user starts inhaling at time T₀. In such an example, the controller component may determine that the next inhalation starting time point is at T₀+3 seconds.

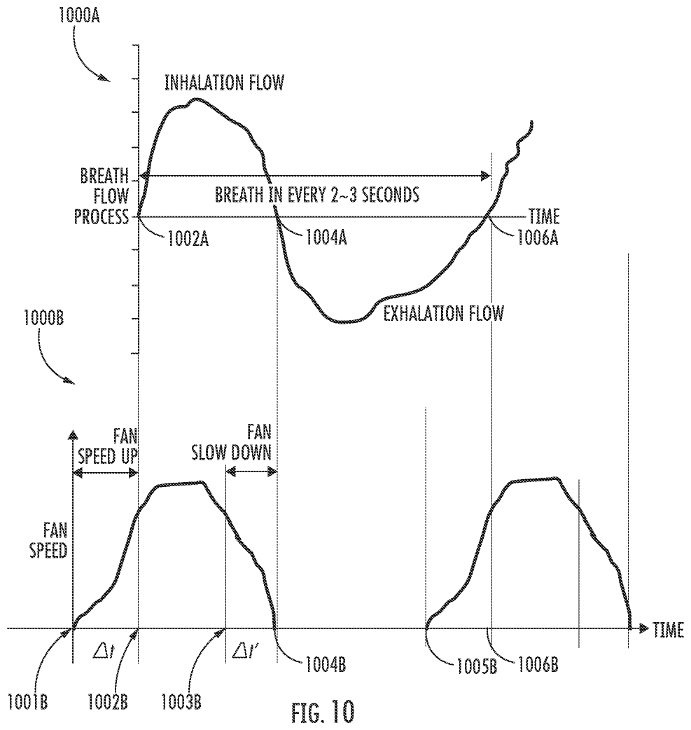

Referring now to FIG. 10, the example breath flow diagram 1000A illustrates an example inhalation starting time point 1002A, and the next example inhalation starting time point 1006A. In some embodiments, the controller component may determine the next example inhalation starting time point 1006A based on the example inhalation starting time point 1002A and the breath rate (e.g. the user completes a breath every 2 to 3 seconds).

Referring back to FIG. 8, subsequent to and/or in response to step/operation 806, the example method 800 proceeds to step/operation 808. At step/operation 808, a controller component (such as, but not limited to, the controller component 301 of the example respiratory protective device 300 described in connection with FIG. 3 above) may set the forward rotation start signal transmission time point based on the inhalation starting time point and the forward rotation speed up adjustment time period.

In some embodiments, the controller component may set the forward rotation start signal transmission time point as a point in time that is prior to the inhalation starting time point determined at step/operation 806 by at least the forward rotation speed up adjustment time period calculated at step/operation 804.

For example, referring now to FIG. 10, the example fan speed diagram 1000B illustrates an inhalation starting time point 1002B and a forward rotation speed up adjustment time period Δt. In such an example, the controller component may set the forward rotation start signal transmission time point at the time point 1001B that is prior to the inhalation starting time point 1002B by the forward rotation speed up adjustment time period Δt. For example, the forward rotation start signal transmission time point can be calculated based on subtracting the forward rotation speed up adjustment time period Δt from the inhalation starting time point 1002B. In some embodiments, the controller component may set the forward rotation start signal transmission time point even prior to the time point 1001B.

Referring back to FIG. 8, subsequent to and/or in response to step/operation 808, the example method 800 proceeds to step/operation 810. At step/operation 810, a controller component (such as, but not limited to, the controller component 301 of the example respiratory protective device 300 described in connection with FIG. 3 above) may transmit a forward rotation start signal to the at least one fan component at the forward rotation start signal transmission time point.

In some embodiments, the forward rotation start signal may include the forward rotation speed value. Referring to FIG. 10, the controller component may transmit the forward rotation start signal that includes the forward rotation speed value to the at least one fan component at the forward rotation start signal transmission time point (for example, at time point 1001B). During the forward rotation speed up adjustment time period Δt, the at least one fan component speeds up. When the user starts inhaling at the inhalation starting time point 1002A, the at least one fan component is running at a speed corresponding to the forward rotation speed value. As another example, the controller component may transmit the forward rotation start signal that includes the forward rotation speed value to the at least one fan component at the forward rotation start signal transmission time point 1005B prior to the example inhalation starting time point 1006B.

Referring back to FIG. 8, subsequent to and/or in response to step/operation 810, the example method 800 proceeds to step/operation 812 and ends.

Referring now to FIG. 9, an example method 900 of determining an example forward rotation stop signal transmission time point for an example fan component in accordance with some example embodiments described herein is illustrated. As described above, the forward rotation stop signal transmission time point refers to a time at which the controller component transmits a forward rotation stop signal to one or more fan components of the example respiratory protective device.

In FIG. 9, the example method 900 starts at step/operation 901. In some embodiments, subsequent to and/or in response to step/operation 901, the example method 900 proceeds to step/operation 903. At step/operation 903, a controller component (such as, but not limited to, the controller component 301 of the example respiratory protective device 300 described in connection with FIG. 3 above) may calculate a forward rotation slow down adjustment time period based at least in part on the forward rotation speed value.

In some embodiments, the forward rotation speed value may be calculated based in accordance with various examples described herein, including, but not limited to, at least FIG. 3 to FIG. 7 described above.

In some embodiments, the forward rotation stop signal comprises an electronic instruction to the at least one fan component to stop rotating. As described above, there may be a time delay between when the forward rotation stop signal is received by the at least one fan component and when the fan component completely stops rotating. For example, the fan component may receive the forward rotation stop signal when it is running, and may require time to slow down.

In the present disclosure, the term “forward rotation slow down adjustment time period” is the time period during which the fan component slows down from a current speed (for example, the forward rotation speed or a reverse rotation speed) to a zero speed. In some embodiments, the forward rotation slow down adjustment time period may be calculated based at least in part on the forward rotation speed value.

For example, the fan component may be a stepped fan that provides different, predetermined settings for the forward rotation speeds, and each predetermined forward rotation speed may correspond to a predetermined forward rotation slow down adjustment time period. In such an example, the controller component may select a predetermined forward rotation slow down adjustment time period that corresponds to a predetermined forward rotation speed as indicated by the forward rotation speed value, and may set the forward rotation slow down adjustment time period as the predetermined forward rotation slow down adjustment time period.

Additionally, or alternatively, the fan component may be a stepless fan that provides continuous adjustments of the forward rotation speeds. In such an example, the controller component may determine the forward rotation slow down adjustment time period based on dividing the forward rotation speed value by the deceleration rate of the fan component. For example, if the forward rotation speed value indicates a speed of 200 RPM, and the deceleration rate of the fan component is 2 RPM per millisecond (e.g. the fan component decreases the rotation speed by 2 RPM per millisecond), the controller component may determine that the forward rotation slow down adjustment time period is 100 milliseconds.

Referring back to FIG. 9, subsequent to and/or in response to step/operation 903, the example method 900 proceeds to step/operation 905. At step/operation 905, a controller component (such as, but not limited to, the controller component 301 of the example respiratory protective device 300 described in connection with FIG. 3 above) may determine an exhalation starting time point based at least in part on the plurality of air pressure indications.

As described above, the air pressure decreases as a user inhales, and the valley air pressure value corresponds to the air pressure when a user completes an inhalation and starts an exhalation (e.g. an exhalation starting time point). Further, the controller component may calculate the breath rate value based at least in part on the plurality of air pressure indications. In some embodiments, the controller component may determine exhalation starting time point based at least in part on the breath rate value.

For example, the controller component may determine that a user completes a breath every 3 seconds, and may determine that a user starts exhaling at time T₀. In such an example, the controller component may determine the next exhalation starting time point at T₀+3 seconds.

Referring now to FIG. 10, the example breath flow diagram 1000A illustrates an example exhalation starting time point 1004A.

Referring back to FIG. 9, subsequent to and/or in response to step/operation 905, the example method 900 proceeds to step/operation 907. At step/operation 907, a controller component (such as, but not limited to, the controller component 301 of the example respiratory protective device 300 described in connection with FIG. 3 above) may set the forward rotation stop signal transmission time point based on the exhalation starting time point and the forward rotation slow down adjustment time period.

In some embodiments, the controller component may set the forward rotation stop signal transmission time point as a point in time that is prior to the exhalation starting time point determined at step/operation 905 by at least the forward rotation slow down adjustment time period calculated at step/operation 903.

For example, referring now to FIG. 10, the example fan speed diagram 1000B illustrates an exhalation starting time point 1004B and a forward rotation slow down adjustment time period Δt′. In such an example, the controller component may set the forward rotation stop signal transmission time point at time point 1003B that is prior to the exhalation starting time point 1004B by the forward rotation slow down adjustment time period Δt′. For example, the forward rotation stop signal transmission time point can be calculated based on subtracting the forward rotation slow down adjustment time period Δt′ from the exhalation starting time point 1004B. In some embodiments, the controller component may set the forward rotation stop signal transmission time point even prior to the time point 1003B.

Referring back to FIG. 9, subsequent to and/or in response to step/operation 907, the example method 900 proceeds to step/operation 909. At step/operation 909, a controller component (such as, but not limited to, the controller component 301 of the example respiratory protective device 300 described in connection with FIG. 3 above) may transmit a forward rotation stop signal to the at least one fan component at the forward rotation stop signal transmission time point.

In some embodiments, the forward rotation stop signal may include electronic instructions to cause the at least one fan component to stop rotating. Referring to FIG. 10, the controller component may transmit the forward rotation stop signal to the at least one fan component at the forward rotation stop signal transmission time point (for example, time point 1003B). During the forward rotation slow down adjustment time period Δt′, the at least one fan component slows down. When the user starts exhaling at the exhalation starting time point 1004B, the at least one fan component has been completely stopped.

Referring back to FIG. 9, subsequent to and/or in response to step/operation 909, the example method 900 proceeds to step/operation 911 and ends.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A respiratory protective device comprising:
a pressure sensor component disposed on an inner surface of the respiratory protective device;
at least one fan component positioned adjacent to an inhalation filtration component of the respiratory protective device; and
a controller component in electronic communication with the pressure sensor component and the at least one fan component, wherein the controller component is configured to:
receive a plurality of air pressure indications from the pressure sensor component, wherein the plurality of air pressure indications comprises a plurality of air pressure values;
calculate a breath pattern indication based on the plurality of air pressure indications, wherein the breath pattern indication comprises a breath depth value and a breath rate value;
determine a forward rotation speed value for the at least one fan component based on the breath depth value of the breath pattern indication; and
determine a forward rotation start signal transmission time point and a forward rotation stop signal transmission time point for the at least one fan component based on the forward rotation speed value and the breath rate value of the breath pattern indication.

2. The respiratory protective device of claim 1, wherein the plurality of air pressure values corresponds to time series data.

3. The respiratory protective device of claim 2, wherein the controller component is configured to:
determine a plurality of peak air pressure values and a plurality of valley air pressure values based on the plurality of air pressure values and the time series data;
calculate a plurality of peak-to-valley height values based on the plurality of peak air pressure values and the plurality of valley air pressure values;
determine a maximum peak-to-valley height value from the plurality of peak-to-valley height values; and
set the breath depth value based at least in part on the maximum peak-to-valley height value.

4. The respiratory protective device of claim 3, wherein, when determining the forward rotation speed value based on the breath depth value, the controller component is configured to:
compare the breath depth value with a previous breath depth value, wherein the previous breath depth value is associated with a previous forward rotation speed value of the at least one fan component.

5. The respiratory protective device of claim 4, wherein the controller component is configured to:
determine that the breath depth value increases from the previous breath depth value;
calculate a breath depth increase value based on subtracting the previous breath depth value from the breath depth value;
determine a forward rotation speed increase value based at least in part on the breath depth increase value; and
set the forward rotation speed value based at least in part on adding the forward rotation speed increase value to the previous forward rotation speed value.

6. The respiratory protective device of claim 4, wherein the controller component is configured to:
determine that the breath depth value decreases from the previous breath depth value;
calculate a breath depth decrease value based on subtracting the breath depth value from the previous breath depth value;
determine a forward rotation speed decrease value based at least in part on the breath depth decrease value; and
set the forward rotation speed value based at least in part on subtracting the forward rotation speed decrease value from the previous forward rotation speed value.

7. The respiratory protective device of claim 1, wherein, when determining the forward rotation start signal transmission time point, the controller component is configured to:
calculate a forward rotation speed up adjustment time period based at least in part on the forward rotation speed value;
determine an inhalation starting time point based at least in part on the plurality of air pressure indications; and
set the forward rotation start signal transmission time point based on the inhalation starting time point and the forward rotation speed up adjustment time period.

8. The respiratory protective device of claim 7, wherein the controller component is configured to:
transmit a forward rotation start signal to the at least one fan component at the forward rotation start signal transmission time point.

9. The respiratory protective device of claim 1, wherein, when determining the forward rotation stop signal transmission time point, the controller component is configured to:
calculate a forward rotation slow down adjustment time period based at least in part on the forward rotation speed value;
determine an exhalation starting time point based at least in part on the plurality of air pressure indications; and
set the forward rotation stop signal transmission time point based on the exhalation starting time point and the forward rotation slow down adjustment time period.

10. The respiratory protective device of claim 9, wherein the controller component is configured to:
transmit a forward rotation stop signal to the at least one fan component at the forward rotation stop signal transmission time point.
